(19) United States
(12) Patent Application Publication
(10) Pub. No.: US 2011/0245422 A1
(43) Pub. Date: Oct. 6, 2011

(54) THERMOPLASTIC POLYMER SYSTEMS MODIFIED BY COPOLYMERS WITH FUNCTIONALISED BLOCKS

(75) Inventors: Jean-Pierre Disson, Vernaison (FR); Thomas Fine, Lyon (FR)

(73) Assignee: Arkema France, Colombes (FR)

(21) Appl. No.: 13/121,781

(22) PCT Filed: Oct. 2, 2009
(86) PCT No.: PCT/FR2009/051877

§ 371 Date: Jun. 15, 2011

(30) Foreign Application Priority Data
Oct. 2, 2008 (FR) 08.56681

(51) Int. Cl. C08L 53/00

(52) U.S. Cl. 525/89; 525/92 R; 525/92 L

(57) ABSTRACT

The present invention relates to thermoplastic polymers modified by means of acrylic block copolymers functionalized by hydrophilic monomers. The subject matter of the invention is a blend of polymers comprising, as matrix polymer, a thermoplastic material which comprises flexible segments of polyether or polyester type and comprising at least one acrylic block copolymer dispersed in said matrix polymer and miscible with the latter, said block copolymer comprising at least one hydrophilic monomer. The modified thermoplastic materials according to the invention maintain very good properties of transparency and, in addition, acquire new properties, in particular mechanical properties, such as a better mechanical strength in the molten state during conversion operations specific to thermoplastic materials, such as extrusion, blow molding or calendering operations.

The present invention relates generally to thermoplastic polymers modified by means of acrylic block copolymers functionalized by hydrophilic monomers.

A definition of block copolymer is given by the International Union of Pure and Applied Chemistry (IUPAC) (Pure Appl. Chem., Vol. 68, No. 12, pp. 2287-2311, 1996). In the context of the present invention, a block copolymer is defined as a macromolecule composed of at least two segments bonded via covalent chemical bonds, it being possible for each segment to be a copolymer or a homopolymer according to the definitions of the IUPAC, and where each segment exhibits at least one characteristic different from those of the adjacent segment. Mention may be made, as known block copolymers, of styrene copolymers of the polystyrene/polyisoprene, polystyrene/polyisoprene/polystyrene, polystyrene/polybutadiene or polystyrene/polybutadiene/polystyrene type and the hydrogenated forms of the latter polymers. There also exist block copolymers in which some blocks are themselves random copolymers, for example block copolymer grades comprising reactive comonomers of maleic anhydride type in one of the two blocks.

The development of anionic polymerization and of controlled radical polymerization made it possible, at the beginning of the 1990s, to synthesize acrylic block copolymers, for example diblocks of poly(methyl methacrylate)/poly(butyl acrylate) (PMMA-pBuA) or poly(methyl methacrylate)/polybutadiene type, or triblocks of poly(methyl methacrylate)/poly(butyl acrylate)/poly(methyl methacrylate) or polystyrene/polybutadiene/poly(methyl methacrylate) type. The first block copolymers comprising combinations of acrylic monomers and of methacrylic monomers are described in patent EP 0 408 429.

In comparison with random copolymers, block copolymers make it possible to obtain novel morphologies, with in particular arrangements in domains of a few nanometers of the various phases formed by each of the blocks. These arrangements are, for example, described in Macromolecules, Vol. 13, No. 6, 1980, pp. 1602-1617, or in Macromolecules, Vol. 39, No. 17, 2006, pp. 5804-5814.

It is also possible to design a block copolymer, one of the blocks of which is compatible with a third polymer acting as matrix. For example, as described in WO 03/062293, a block copolymer of PMMA-pBuA-PMMA type introduced into a PMMA matrix results, by virtue of the affinity of the PMMA arms of the block polymer with the PMMA matrix, in the fine distribution of flexible domains of pBuA, acting as impact reinforcing agent. More particularly, it concerns the use of block copolymers comprising hydrophobic monomers to strengthen thermoplastic matrices, in order to obtain resins which are simultaneously transparent and impact resistant. The block copolymers described in this document have a general formula B-(A)ₙ, n being between 2 and 20, B being a polymer block of flexible nature with a glass transition temperature (Tg) of less than 0° C. and A being a polymer block of rigid nature with a Tg of greater than 0° C.

However, the disclosure of this document is limited to the advantages resulting from the modification of thermoplastic matrices by means of predominantly hydrophobic block copolymers of formula B-(A)ₙ, the block A of which is of the same nature or compatible with the matrix.

Systems combining thermoplastic matrices comprising polyether or polyester segments with acrylic copolymers comprising hydrophilic groups have also been described; nevertheless, these acrylic copolymers are not block copolymers. For example, in example 15 of application U.S. Pat. No. 3,879,943, a copolymer of 90% dimethylacrylamide and 10% butyl acrylate is incorporated in a thermoplastic polyurethane, Estane® 5702, in order to improve the water-absorption properties thereof. However, the hydrophilic acrylic copolymer does not correspond to a block structure and, a fortiori, does not comprise any hydrophobic block. This is because the latter is obtained simply by conventional radical polymerization, as described in example 2 of said document: the monomers are introduced into a reactor at the same time as an initiator of azobisisobutyronitrile type. No additive of those known to produce controlled radical polymerizations is introduced. Under these conditions, the distribution of the monomers in the copolymer corresponds to a random arrangement dependent on the reactivity of each of the monomers. For fuller details explaining the differences between a conventional radical polymerization and a controlled radical polymerization, reference may be made, for example, to Chapter 8 of “Handbook of Radical Polymerization”, John Wiley & Sons, 2002.

It has now been found that thermoplastic materials with improved mechanical properties can be obtained by modifying a thermoplastic matrix comprising flexible segments of polyester or polyether type with acrylic block copolymers functionalized by hydrophilic monomers.

Thermoplastic polymers comprising flexible segments of polyester or polyether type are encountered, for example, in the materials of copolyamide, copolyester, thermoplastic polyurethane or polyacetal type. They are used in various applications, such as footwear soles, pipes, or flexible mechanical parts used in the automobile industry (bellows, seals, gears, belts), which applications subject these materials to conditions of wear, of abrasion and of mechanical stresses. A continual search is underway to improve their mechanical properties, such as their elongation at break, resistance to braking or the abrasion resistance. Furthermore, their hydrophilicity renders the processing sensitive to the conversion conditions and can thus detrimentally affect the properties of the material.

It is thus necessary to improve the window for processing thermoplastic polymers comprising flexible segments of polyester or polyether type by controlling the rheology and the mechanical properties of the polymer in the molten state. Finally, some applications of thermoplastic polymers comprising flexible segments of polyether or polyester type, such as tubes or connections for medical applications, require not only good mechanical properties but also transparency. There thus exists a need to improve mechanical properties of thermoplastic materials which comprise flexible segments of polyether or polyester type, in general, in particular during extrusion, blow molding or calendering operations, while maintaining the properties intrinsic to these materials, such as the transparency, the surface appearance or the adhesion properties, at a level at least equal to that of the unmodified material.

An aim of the present invention is to provide novel thermoplastic materials modified by means of functionalized acrylic block copolymers and exhibiting improved properties.

According to a first aspect, a subject matter of the invention is a blend of polymers comprising:
as matrix polymer, a thermoplastic material which comprises flexible segments of polyether or polyester type having a Tg of less than 20° C., as measured by differential scanning calorimetry (DSC),
and at least one acrylic block copolymer dispersed in said matrix polymer and miscible with the latter, said block copolymer comprising at least one hydrophilic monomer.

The invention is targeted very particularly at matrix polymers in which the ester or ether functional group is in the polymer backbone.

In a preferred alternative embodiment, the thermoplastic material is an elastomer, the polyether or polyester segments of the matrix polymer having a Tg of less than 10° C.

According to a second aspect, the invention relates to the use of acrylic block copolymers comprising at least one hydrophilic monomer to strengthen thermoplastic polymers comprising flexible segments of polyether or polyester type.

In the present invention, the term “hydrophilic monomers” denotes monomers which can form hydrogen bonds with water and polar solvents; these are molecules which exhibit oxygen or nitrogen atoms in their base structure (backbone).

The hydrophilicity of a monomer can also be defined by means of the corresponding homopolymers, which are water-soluble or water-dispersible or which have an ionic form which is water-soluble or water-dispersible.

A homopolymer is “water-soluble” if it forms a clear solution when it is in solution at 5% by weight in water at 25° C.

A homopolymer is “water-dispersible” if, at 5% by weight in water and at 25° C., it forms a stable suspension of fine particles which are generally spherical. The mean size of the particles constituting said dispersion is less than 1 mm and more generally varies between 5 and 400 nm, preferably from 10 to 250 nm. These particle sizes are measured by light scattering.

The hydrophilicity of a monomer can also be assessed by means of the value of the logarithm of the 1-octanol/water apparent partition coefficient, also referred to as log P or log K_{ow}; it may be considered that a monomer is hydrophilic when this value is less than or equal to 2, for example between −8 and 2. The log P values are known and are determined according to a standard test which determines the concentration of the monomer in the octanol and in the water.

The term “hydrophobic monomer” is understood to mean a monomer molecule which rejects water, in other words which is insoluble in water, and thus cannot create hydrogen bonds with water molecules. Its base structure is composed of hydrogen and carbon atoms.

### DETAILED DESCRIPTION

The Applicant Company has found that the fact of functionalizing acrylic block copolymers with various hydrophilic monomers greatly facilitates the miscibility of these copolymers with thermoplastic polymer materials comprising flexible segments of polyether or polyester type. These thermoplastic materials exhibit intrinsic properties, such as abrasion resistance, good mechanical properties at high temperature and a soft touch. The modified thermoplastic materials according to the invention maintain very good properties of transparency (which testifies to the good miscibility between the resin and the block copolymers) and, in addition, acquire new properties, in particular mechanical properties, such as a better mechanical strength in the molten state during conversion operations specific to thermoplastic materials, such as extrusion, blow molding or calendering operations.

The invention is targeted, according to a first aspect, at a blend of polymers comprising:
as matrix polymer, a thermoplastic material which comprises flexible segments of polyether or polyester type having a Tg of less than 20° C., as measured by differential scanning calorimetry (DSC),
and at least one acrylic block copolymer dispersed in said matrix polymer and miscible with the latter, said block copolymer comprising at least one hydrophilic monomer.

### Matrix Polymer

The thermoplastic material forming the matrix polymer according to the invention comprises flexible segments of polyether or polyester type.

The term “flexible segment” is understood to mean, in the context of the present invention, any polymer fragment of homogeneous structure, the Tg of which is less than 20° C., preferably less than 10° C. and more preferably less than 0° C.

The matrix polymer is preferably chosen from: polyester homopolymers, polyether homopolymers, polyacetals, such as, for example, polyoxymethylenes or copolymers of polyoxymethylene and of trioxane, or block copolymers categorized in the family of the thermoplastic elastomers, such as copolyester/esters and copolyester/ethers, polyether-block-amides or polyurethane elastomers (TPUs) of TPU/ether, TPU/ester or TPU/polycaprolactone type, or also polymers where the flexible segment or a portion of the latter comprises thioether functional groups.

In a preferred alternative embodiment, the thermoplastic material is an elastomer exhibiting a Tg of the polyether or polyester block of less than 10° C.

In the context of the invention, the term “thermoplastic material” is understood to mean any material based on polymers having few or no covalent bonds between the polymer chains and capable of softening under the effect of temperature in order to be processed according to techniques such as injection molding, extrusion, extrusion/blow molding or calendering.

Preferably, the percentage of flexible segments in the matrix polymer is from 20 to 100% by weight, preferably from 40 to 90% by weight. The presence of these flexible segments provides good miscibility with the acrylic block copolymer of the invention, as proven, inter alia, by the excellent qualities of transparency exhibited by the blends of polymers forming the subject matter of the invention.

Other properties of thermoplastic polymers can be improved by virtue of the incorporation, in these matrices, of acrylic block copolymers functionalized by hydrophilic monomers, for example the ability to be printed or lacquered, the resistance to aging subsequent to exposure to UV radiation, or the chemical resistance, in particular to oils and hydrocarbons.

The matrix polymer exhibits a molecular weight ranging from 10 000 to 1 000 000 daltons, preferably from 20 000 to 250 000 daltons.

### Acrylic Block Copolymer(s)

This copolymer is chosen from A-B-C and A-B block copolymers in which:
each block is connected to the other by means of a covalent bond or of an intermediate molecule connected to one of the blocks via a covalent bond and to the other block via another covalent bond,
at least one of the monomers results from an acrylic or methacrylic acid derivative,
the block A is a homopolymer of a hydrophilic monomer or a copolymer of several hydrophilic monomers or a copolymer of at least one hydrophilic monomer and of at least one hydrophobic acrylic or methacrylic monomer,
the block C is a homopolymer or a copolymer of (meth)acrylic or styrene monomers. It can comprise one or more hydrophobic monomers and/or one or more hydrophilic monomers,
the block B is incompatible with the block A and the optional block C; its glass transition temperature Tg is less than 20° C.

However, more branched structures can be envisaged for the acrylic block copolymer, without departing from the scope of the invention.

Preferably, the block copolymer is such that the block B is incompatible with the side block(s) A and C, that is to say that they exhibit a Flory-Huggins interaction parameter χ_{AB} of greater than 0 at ambient temperature. This results in phase microseparation (observable by scanning electron microscopy), with formation of a biphasic structure at the macroscopic scale. The phase separation is reflected by the formation of domains comprising segments resulting from the block B and of domains comprising segments resulting from the block A and/or from the block C, the size of these domains ranging from a few nanometers to several tens of nanometers.

The block A is a homopolymer of a hydrophilic monomer or a copolymer of several hydrophilic monomers or a copolymer of at least one hydrophilic monomer and at least one hydrophobic acrylic or methacrylic monomer. The block A can also comprise a styrene monomer, preferably less than 10% by weight. In the case where the block A is a copolymer of at least one hydrophilic monomer and of at least one hydrophobic acrylic or methacyrlic monomer, the hydrophobic acrylic or methacrylic monomer(s) are preferably C₁-C₈ alkyl methacrylates and more preferably methyl methacrylate.

Mention may be made, as example of hydrophilic monomer, of:
acrylic or methacrylic acid, and their anionic forms obtained by complete or partial neutralization,
amides derived from these acids, such as, for example, dimethylacrylamide (DMA), acrylamide, N-methylacrylamide or N-hydroxyethylacrylamide,
amino(meth)acrylates,
optionally quaternized 2-aminoethyl acrylates or methacrylates,
optionally alkoxylated polyoxyalkylene (meth)acrylates, for example polyethylene glycol (PEG) (meth)acrylates, methoxypolyethylene glycol (meth)acrylates or polypropylene glycol (meth)acrylates,
maleic acid, itaconic acid, fumaric acid or maleic anhydride,
hydroxy(meth)acrylates, for example 2-hydroxyethyl (meth)acrylate, 2-methoxyethyl (meth)acrylate or 4-hydroxybutyl acrylate,
water-soluble vinyl monomers, such as N-vinylpyrrolidone or 4-vinylpyridine.
   Advantageously, the polyethylene glycol group of the polyethylene glycol (meth)acrylates has a weight ranging from 300 g/mol to 10 000 g/mol.

In the case where the block A is a copolymer of at least one hydrophilic monomer and of at least one hydrophobic acrylic or methacrylic monomer, the proportion of hydrophilic monomer will be greater than 5% by weight, preferably greater than 10%.

The block B is elastomeric and essentially hydrophobic, that is to say devoid of hydrophilic monomer, but can comprise a small fraction thereof (less than 5% by weight of hydrophilic monomer).

Advantageously, the Tg of 13 is less than 20° C., preferably less than 10° C. and more preferably less than 0° C.

The monomers used to synthesize the elastomeric block B are (meth)acrylates, preferably C₁-C₈ alkyl (meth)acrylates, chosen so that the Tg of the copolymer is less than 20° C. Mention may be made, as example of (meth)acrylic monomers of low Tg, of ethyl acrylate (−24° C.), butyl acrylate (BuA) (−54° C.), 2-ethylhexyl acrylate (−85° C.), hydroxyethyl acrylate (−15° C.), butyl methacrylate (20° C.) and 2-ethylhexyl methacrylate (−10° C.). Use is advantageously made of butyl acrylate. The (meth)acrylates are different from those of the block A in order to observe the condition of incompatibility between B and A.

The block B can also comprise a styrene monomer, preferably less than 10% by weight.

The diblock A-B has a number-average molar mass which can be between 10 000 g/mol and 500 000 g/mol, preferably between 20 000 and 200 000 g/mol. The diblock A-B is advantageously composed of a fraction by weight of A of between 5 and 95% and preferably between 15 and 85%.

The block C is a homopolymer or a copolymer of (meth)acrylic or styrene monomers. It can comprise one or more hydrophobic monomers and/or one or more hydrophilic monomers.

The monomers and optionally comonomers of the block C are chosen from the same family of monomers and optionally comonomers as those described above for the block A; however, the presence of the hydrophilic monomer is not obligatory. The two blocks A and C of the triblock A-B-C can be identical or different. They can also be different in their molar masses but composed of the same monomers. If the block C comprises a hydrophilic monomer, the latter can be identical to or different from the hydrophilic monomer of the block A. In a preferred alternative form of the invention, the block C has the same composition and the same molecular weight as the block A.

The block polymers A, B and C can be manufactured by any polymerization means suitable for producing block structures and in particular by controlled radical polymerization. The term “controlled radical polymerization” is understood to mean a conventional radical polymerization in which at least one of the stages chosen from the initiation, the propagation, the termination and the transfer is controlled. Mention may be made, as example of control, of the reversible deactivation of the growing macroradicals. This reversible deactivation can be brought about by the addition of nitroxides to the reaction medium. A persistent radical is, for example, TEMPO (2,2,6,6-tetramethyl-1 piperidinyloxy), which captures the macroradicals and results generally in homopolymers with very narrow polydispersities, thus conferring a living nature on the radical polymerization. Mention may also be made of β-phosphorylated molecules having a hydrogen in the a position with respect to the nitroxide functional group.

The triblock A-B-C has a number-average molar mass which can be between 10 000 g/mol and 500 000 g/mol, preferably between 20 000 and 200 000 g/mol. Advantageously, the triblock A-B-C has the following compositions, expressed as fraction by weight, the total being 100%:

A+C: between 10 and 80% and preferably between 25 and 70%,
B: between 90 and 20% and preferably between 75 and 30%.

As regards the blend of polymers according to the invention, this comprises, by weight, the total coming to 100%:
from 0.5 to 70% of at least one block copolymer;
from 30 to 99.5% of matrix polymer.

The blend is obtained using all the techniques far blending thermoplastics known to a person skilled in the art, for example by extrusion. The blend can comprise ingredients other than the polymers described above, for example plasticizers, lubricants, heat or UV stabilizers, antioxidants, other polymers, inorganic fillers or reinforcements, dyes or pigments.

### EXAMPLES

### Example 1

### Synthesis of Polymers by the Solvent Route

1. The first part of this example illustrates the synthesis of a poly(n-butyl acrylate) polymer intended to form one of the blocks of the copolymers described in the context of the invention.

The following are introduced into a polymerization reactor equipped with a variable-speed stirrer motor, with inlets for the introduction of the reactants, with branch pipes for the introduction of inert gases in order to drive off oxygen, with probes for measuring the temperature, with a system for condensation of vapors with reflux and with a jacket which makes it possible to heat/cool the contents of the reactor by virtue of the circulation in the jacket of a heat-exchange fluid:
“A” g of n-butyl acrylate; and
“a” g of polyfunctional alkoxyamine having the following formula:
   (The parameters “A”, “a”, “B”, “C” and “D” mentioned in example 1 are explained in table 1).

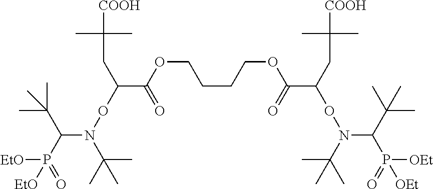

After degassing several times with nitrogen, the reaction medium is brought to 115° C. and this temperature is maintained by thermal regulation for several hours. Samples are taken throughout the reaction in order to:
determine the polymerization kinetics by gravimetric analysis (measurement of solid contents);
monitoring of the change in the number-average molecular weight (Mn) as a function of the conversion of the monomer to polymer.
   When a conversion of 80% is reached, the reaction medium is cooled to 60° C. and the residual n-butyl acrylate is removed by evaporation under vacuum.
2. The second part of this example illustrates the reinitiation of the poly(n-butyl acrylate) prepared above by methyl methacrylate or a mixture of methyl methacrylate and of dimethylacrylamide.

“B” g of methyl methacrylate, “C” g of dimethylacrylamide and “D” g of toluene are added at 60° C. to the difunctional poly(n-butyl acrylate) prepared in the first part of this example. The reaction medium is then heated at 105° C. for 2 h and then at 120° C. for an additional 2 h. After returning to ambient temperature, the copolymer solution is withdrawn from the reactor and the residual monomers and the solvents are removed by evaporation under vacuum.

TABLE 1

| | | “a” g of | | | |
|---|---|---|---|---|---|
| | “A” g of | poly- | “B” g of | “C” g of | |
| | n-butyl | functional | methyl | dimethyl- | “D” g of |
| | acrylate | alkoxyamine | methacrylate | acrylamide | toluene |
| P1 | 625 | 15.03 | 526 | 132 | 1840 |
| CE1 | 625 | 19.24 | 1467 | 0 | 600 |
| CE2 | 625 | 9.62 | 1250 | 0 | 600 |

### Polymer P1 (According to the Invention)

The polymer P1 is a triblock ABC where the blocks A and C are identical. The block B is a poly(butyl acrylate) representing 47% by weight of the block copolymer ABC. The blocks A and C are composed of a copolymer obtained from 80% of methyl methacrylate monomer, which is a hydrophobic monomer, and from 20% of N,N-dimethylacrylamide monomer, which is hydrophilic. The total number-average molecular weight Mn of the copolymer P1 is 50 000.

Two other copolymers were used by way of comparison:

### Polymer CE1 (Comparative)

The polymer CE1 is a triblock ABC where the blocks A and C are identical. The block B is a poly(butyl acrylate) representing 50% by weight of the block copolymer ABC. The blocks A and C are identical and formed of poly(methyl methacrylate) (PMMA). It thus does not comprise a hydrophilic monomer. The number-average molecular weight of the polymer CE1 is 60 000.

### Polymer CE2 (Comparative)

The polymer CE2 is a triblock ABC where the blocks A and C are identical. The block B is a poly(butyl acrylate) representing 50% by weight of the block copolymer ABC. The blocks A and C are identical and formed of poly(methyl methacrylate). Thus, they do not comprise a hydrophilic monomer. The number-average molecular weight of the polymer CE2 is 100 000.

### Example 2

The polymers P1, CE1 and CE2 are introduced, in a proportion of 2%, into a Thermoplastic PolyUrethane, based on a polydiol of ether type (TPU ether), Elastollan® 1185A. The blend of granules is homogenized by recirculation of the material in a DSM microextruder. The barrel temperatures are set at 190° C. and the screw speed at 50 revolutions/min. After recirculating in the extruder for 5 min, the material is sent to the extrusion die and the appearance of the rods is observed.

The unmodified Elastollan® 1185A results in a transparent extrudate, as does that modified with 2% of the triblock copolymer P1. The extrudates using the polymers CE1 and CE2 are highly clouded. This testifies to better compatibility between the polymer P1 and the matrix polymer.

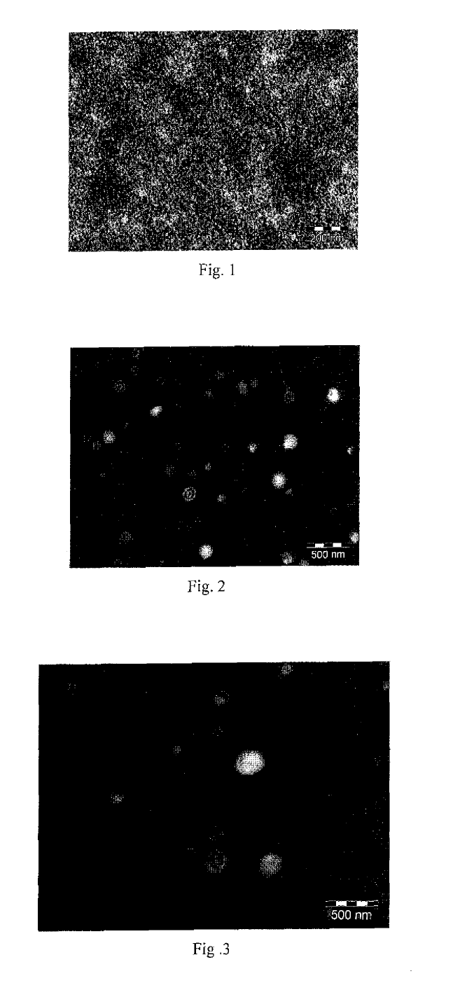

A transmission electron microscopy photograph after labeling microtome sections with an aqueous solution comprising 2% of phosphotungstic acid and 2% of benzyl alcohol reveals, for the system modified by the polymer P1, a fine and uniform microstructure (appended FIG. 1), whereas, with the polymers CE1 and CE2, large nodules are visible (appended FIGS. 2 and 3 respectively). On these photographs, the process of labeling with phosphotungstic acid results in the areas rich in poly(butyl acrylate) being made to clearly stand out. More specifically, it may be observed that, in the case of the modification of the Elastollan® 1185A by CE1, the nodules have a diameter of about 100 nm, and even greater in some cases. In the case of a modification by CE2, nodules having a size varying between 100 and 400 nm are also observed.

As it is known that the phenomenon of light scattering is only noticeable when the size of the domains becomes close to the wavelength of visible light λ/4=100 nm, these microscopy photographs explain why the modification by P1 results in a perfectly transparent blend, in the case of CE1, a translucent blend and, in the case of CE2, a highly clouded blend.

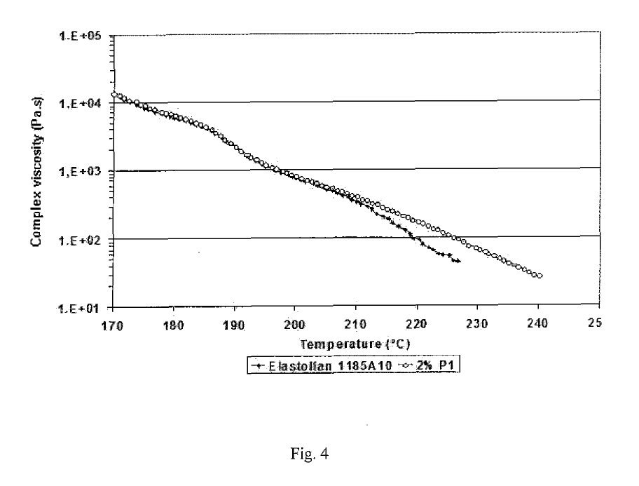

A rheological analysis of the behavior of the blends in a molten medium was also carried out and is illustrated in the appended FIG. 4. These curves show that the addition of 2% of P1 makes it possible to retain a high viscosity at temperatures where the TPU alone is difficult to convert. The window of processability is improved in this direction.

### Example 3

The polymers described in table 2 are prepared according to a procedure similar to that of example 1. The symbol “MPEGMA” corresponds to methoxypolyethylene glycol methacrylate. The grade used is Bisomer® 350MA from Cognis. The symbol “MAA” corresponds to methacrylic acid, produced by Arkema. The symbol “DMA” corresponds to dimethylacrylamide, available from Jarchem. The symbol “BuA” corresponds to n-butyl acrylate, available from Arkema. The symbol “MMA” corresponds to methyl methacrylate, also supplied by Arkema. The fractions shown correspond to the fraction by weight of each monomer polymerized in the block concerned. The symbol “p” shows that it is the polymer, the symbol “co” a copolymer. In the examples in the table, the copolymers are symmetrical and the blocks A and C are identical.

TABLE 2

| | | | Mn of the | % by weight |
|---|---|---|---|---|
| | | | block | of the |
| | Blocks A and C | Block B | polymer, g/mol | block B |
| P1 | Co (MMA/DMA | pBuA 100 | 50 000 | 47 |
| | 80/20) | | | |
| P2 | Co (MMA/DMA | pBuA 100 | 50 000 | 60 |
| | 70/30) | | | |
| P3 | Co | pBuA 100 | 50 000 | 50 |
| | (MMA/MPEGMA | | | |
| | 80/20) | | | |
| P4 | Co (MMA/MAA | pBuA 100 | 55 000 | 40 |
| | 90/10) | | | |
| CE1 | PMMA 100 | pBuA 100 | 60 000 | 50 |

The acrylic polymers are introduced, in a proportion of 5%, into a Thermoplastic PolyUrethane, based on a polydiol of ether type (TPU ether), Estane® 58887, or on a polydiol of ester type (TPU ester), Estane® 58206. The blend of granules is homogenized by recirculation of the material in a DSM microextruder. The barrel temperatures are set at 190° C. and the screw speed at 100 revolutions/min. After recirculating for 5 min in the extruder, the material is sent to a mold which makes it possible to obtain a test specimen for the tensile test. The tensile tests are carried out according to the standard ISO527 on test specimens corresponding to the IBA geometry defined in this standard.

The observations and results are summarized in table 3.

TABLE 3

| | TPU ether matrix | | | TPU ester matrix | | |
|---|---|---|---|---|---|---|
| | | Resis- | Elon- | | Resis- | Elon- |
| | | tance | gation | | tance | gation |
| | Trans- | to break- | at break | Trans- | to break- | at break |
| | parency | ing (MPa) | (%) | parency | ing (MPa) | (%) |
| Without | ++ | 24.5 | 365 | + | 20 | 295 |
| copoly- | | | | | | |
| mer | | | | | | |
| 5% P1 | ++ | 42 | 520 | + | 37 | 390 |
| 5% P2 | ++ | 35 | 525 | ++ | 25 | 330 |
| 5% P3 | + | 42 | 570 | + | 23 | 340 |
| 5% P4 | 0 | 31 | 450 | 0 | 32 | 350 |
| 5% CE1 | — | 27 | 380 | — | 36 | 340 |

++: very good transparency;
+: good transparency;
0: translucent product;
—: opaque product

1. A blend of polymers comprising:
as the matrix polymer, a thermoplastic material which comprises flexible segments of polyether or polyester having a Tg of less than 20° C., as measured by differential scanning calorimetry (DSC),
and at least one acrylic block copolymer dispersed in said matrix polymer and miscible with said matrix polymer, said acrylic block copolymer comprising at least one hydrophilic monomer unit.

2. The blend of polymers as claimed in claim 1, in which the polyether or polyester segments of the matrix polymer have a Tg of less than 10° C.

3. The blend of polymers as claimed in claim 1, in which the polyether or polyester contains a ester or ether functional group is in the polymer backbone of the matrix polymer.

4. The blend of polymers as claimed in claim 1, in which the percentage of flexible segments in the matrix polymer is from 20 to 100%.

5. The blend of polymers as claimed in claim 1, comprising, by weight, the total coming to 100%:
from 0.5 to 70% of at least one acrylic block copolymer;
from 30 to 99.5% of matrix polymer.

6. The blend of polymers as claimed in claim 1, in which the matrix polymer is selected from the group consisting of: polyester homopolymers, polyether homopolymers, polyacetals, polyoxymethylenes, or copolymers of polyoxymethylene and of trioxane, thermoplastic elastomer block copolymers, copolyester/esters, copolyester/ethers, polyether-block-amides, polyurethane elastomers (TPUs) of TPU/ether, TPU/ester or TPU/polycaprolactone, and polymers where the flexible segment or a portion of the latter comprises thioether functional groups.

7. The blend of polymers as claimed in claim 1, in which the molecular weight of the matrix polymer varies from 10 000 to 1 000 000 Da.

8. The blend of polymers as claimed claim 1, in which the acrylic block copolymer is chosen from A-B-C and A-B block copolymers in which:
each block is connected to the other by means of a covalent bond or of an intermediate molecule connected to one of the blocks via a covalent bond and to the other block via another covalent bond,
at least one of the monomers results from an acrylic acid or methacrylic acid derivative,
the block A is a homopolymer of a hydrophilic monomer or a copolymer of several hydrophilic monomers or a copolymer of at least one hydrophilic monomer and of at least one hydrophobic acrylic or methacrylic monomer,
the block C is a homopolymer or a copolymer of (meth)acrylic or styrene monomers comprising one or more hydrophobic monomers and/or one or more hydrophilic monomers,
the block B is elastomeric and comprises less than 5% by weight of hydrophilic monomer.

9. The blend of polymers as claimed in claim 8, in which the block B has a glass transition temperature Tg of less than 20° C. and is incompatible with the block A and the optional block C, this incompatibility being reflected by a phase microseparation at the molecular level with formation of domains comprising segments resulting from the block B and of domains comprising segments resulting from the block A and/or from the block C.

10. The blend of polymers as claimed claim 8, in which the proportion of hydrophilic monomer in the block A is greater than 5% by weight, when the block A is a copolymer of at least one hydrophilic monomer and of at least one hydrophobic acrylic or methacrylic monomer.

11. The blend of polymers as claimed in claim 1, in which the hydrophilic monomer is selected from the group consisting of:
acrylic or methacrylic acid, and their anionic forms obtained by complete or partial neutralization,
amides derived from these acids, dimethylacrylamide (DMA), acrylamide, N-methylacrylamide, N-hydroxyethylacrylamide,
amino(meth)acrylates,
2-aminoethyl acrylates or methacrylates that are optionally quaternized
polyoxyalkylene (meth)acrylates that are optionally alkoxylated, polyethylene glycol (PEG) (meth)acrylates, methoxypolyethylene glycol (meth)acrylates, polypropylene glycol (meth)acrylates,
maleic acid, itaconic acid, fumaric acid, maleic anhydride,
hydroxy(meth)acrylates, 2-hydroxyethyl (meth)acrylate, 2-methoxyethyl (meth)acrylate, 4-hydroxybutyl acrylate,
water-soluble vinyl monomers, N-vinylpyrrolidone, and 4-vinylpyridine.

12. The blend of polymers as claimed in claim 8, in which the acrylic block copolymer is a triblock A-B-C with a number-average molar mass of between 10 000 g/mol and 500 000 g/mol and exhibits the following composition, expressed as fraction by weight: A+C: between 10 and 80%; B: between 90 and 20%.

13. The blend of polymers as claimed in claim 12, in which the block C has the same composition and the same molecular weight as the block A.

14. The blend of polymers as claimed in claim 13, in which the matrix polymer is a thermoplastic polyurethane based on a polydiol of ether type and the block copolymer is a triblock, the central block of which is a poly(butyl acrylate) and the side blocks of which are formed of the copolymer of methyl methacrylate (MMA) and of dimethylacrylamide (DMA).

15. The blend of polymers as claimed in claim 14, in which said side blocks are formed of 80% PMMA and of 20% by weight PDMA.

16. The blend of polymers as claimed in claim 8, in which the acrylic block copolymer is a diblock A-B with a number-average molar mass of between 10 000 g/mol and 500 000 g/mol, and is composed of a fraction by weight of A of between 5 and 95%.

17. A method of strengthening thermoplastic polymers comprising the step of admixing acrylic block copolymers comprising at least one hydrophilic monomer to thermoplastic polymers comprising flexible segments of polyether or polyester type having a Tg of less than 20° C., as measured by differential scanning calorimetry (DSC).

18. The blend of polymers as claimed in claim 2, in which the polyether or polyester segments of the matrix polymer have a Tg of less than 0° C.

19. The blend of polymers as claimed in one claim 4, in which the percentage of flexible segments in the matrix polymer is from 40 to 90%.

20. The blend of polymers as claimed claim 10, in which the proportion of hydrophilic monomer in the block A is greater than 105% by weight.
